(19) United States
(12) Patent Application Publication
(10) Pub. No.: US 2007/0139353 A1
(43) Pub. Date: Jun. 21, 2007

(54) Liquid crystal display television capable of automatically turning off a backlight source and method therefor

(75) Inventors: Shih-Hua Tseng, Taipei City (TW); Che-Hsuan Liu, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/362,204

(22) Filed: Feb. 27, 2006

(30) Foreign Application Priority Data
Dec. 15, 2005 (TW) 094144499

(51) Int. Cl. G09G 3/36

(52) U.S. Cl. 345/102

(57) ABSTRACT

A liquid crystal display television capable of automatically turning off a backlight source is provided, which turns off the backlight source in case of no video signal. The method includes the steps of: (A) selecting a signal source as a working signal source for the liquid crystal display television; (B) determining whether the working signal source contains a video signal; (C) determining whether an instruction is received when no video signal is determined in step (B); (D) further determining whether a period of no video signal exceeds a predetermined time when no instruction received is determined in step (C); and (E) turning off the backlight source on a panel of the liquid crystal display television when the period of no video signal exceeding the predetermined time is determined in step (D).

### BACKGROUND OF THE INVENTION

1. Field of the Invention

The invention relates to a power saving technique for liquid crystal display televisions and, more particularly, to a liquid crystal display television capable of automatically turning off a backlight source and a method therefor.

2. Description of Related Art

As semiconductor processes have developed rapidly, more transistors can be manufactured in a same area such that electronic devices have the enhanced functions and can be made light, thin and small. Liquid crystal display televisions that generally represent the high-technology image have the feature of miniaturization, as compared to typical CRT televisions. In addition, liquid crystal display televisions have a wide screen to provide a better visual enjoyment.

A typical liquid crystal display television displays a blue or black frame when a signal is not received. FIG. 1 is a flowchart of a process performed by a typical liquid crystal display television when a signal is not received. In step S110, the liquid crystal display television selects a signal source as a working signal source. Step S120 determines if the working signal source contains a video signal; if yes, step S140 is executed; and if not, step S130 is executed. Step S130, which indicates that the working signal source does not have the video signal, produces a blue or black frame to indicate no signal. Step S140, which indicates that the working signal source contains the video signal, decodes the video signal and outputs corresponding image. Step S150 turns on the backlight source on a panel of the liquid crystal television to display the image.

However, the screen display function of the typical liquid crystal display television is still working, even a blue or black frame is produced when the signal source has no video signal. Accordingly, the power is wasted.

Therefore, it is desirable to provide an improved liquid crystal display television and the method therefor to mitigate and/or obviate the aforementioned problems.

### SUMMARY OF THE INVENTION

The object of the invention is to provide a liquid crystal display television capable of automatically turning off a backlight source and the method therefor, which can automatically turn off the backlight source on a panel of the liquid crystal display television when a signal source received by the liquid crystal display television has no video signal, thereby saving the power.

In accordance with one aspect of the present invention, there is provided a liquid crystal display television capable of automatically turning off a backlight source on a panel thereof. The liquid crystal display television turns off the backlight source on the panel in case of no video signal. The liquid crystal display television includes a video signal receiving terminal, an image decoder, a liquid crystal television panel and a controller. The video signal receiving terminal receives a video signal and demodulates the video signal to thereby produce an image transport stream and an audio transport stream. The image decoder is connected to the video signal receiving terminal in order to receive the image transport stream and decode the image transport stream to thus produce an image signal. The image decoder has a flag containing a first state and a second state. The first state indicates that an image transport exists, and the second state indicates that the image transport does not exist. The liquid crystal television panel receives the image signal corresponding to the image transport stream for playing and has a backlight control terminal with a first level and a second level. When the backlight control terminal is at the first level, a backlight source on the liquid crystal display television panel is turned on. When the backlight control terminal is at the second level, the backlight source on the liquid crystal display television panel is turned off. The controller is connected to the image decoder and the liquid crystal display television panel for initialization and working mode setup. The controller produces a control signal to set the backlight control terminal to the first level when the flag is detected as the first state, and to the second level when the flag is detected as the second state.

In accordance with another aspect of the present invention, there is provided a method capable of automatically turning off a backlight source on a panel of a liquid crystal display television. The method turns off the backlight source on the panel of the liquid crystal display television in case of no video signal. The method includes the steps: (A) selecting a signal source as a working source for the liquid crystal display television; (B) determining whether the working signal contains a video signal; (C) determining whether an instruction is received when no video signal is determined in step (B); (D) determining whether a period of no video signal exceeds a predetermined time when no instruction received is determined in step (C); and (E) turning off the backlight source on the panel of the liquid crystal display television when the period of no video signal exceeding the predetermined time is determined in step (D).

After turning off the backlight source on the panel of the liquid crystal display television, the backlight source can be automatically turned on when the working source contains a video signal or an instruction is received.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a process performed by a typical liquid crystal display television when a signal is not received;

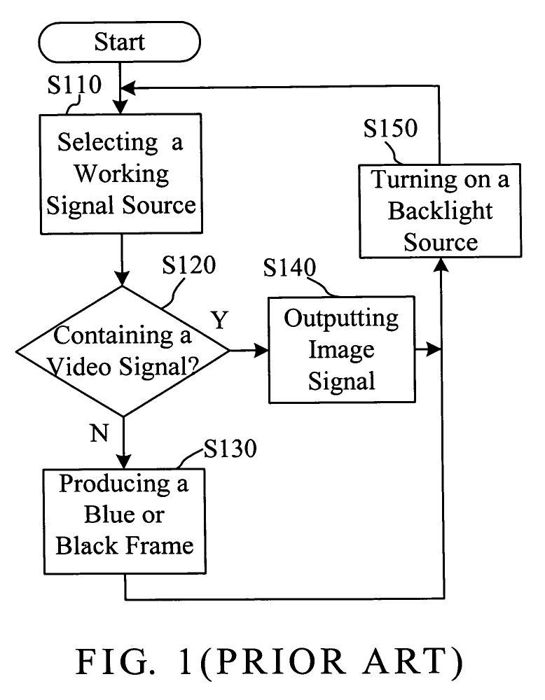

FIG. 2 is a block diagram of a liquid crystal display television capable of automatically turning off a backlight source on a panel thereof in accordance with the invention; and

FIG. 3 is a flowchart of a method capable of automatically turning off a backlight source on a panel of a liquid crystal display television in accordance with the invention.

### DETAILED DESCRIPTION OF THE PREFERRED EMBODIMENT

The liquid crystal display television of the present invention can automatically turn off a backlight source on a panel thereof when a signal source received by the liquid crystal display television has no video signal, thereby saving the power.

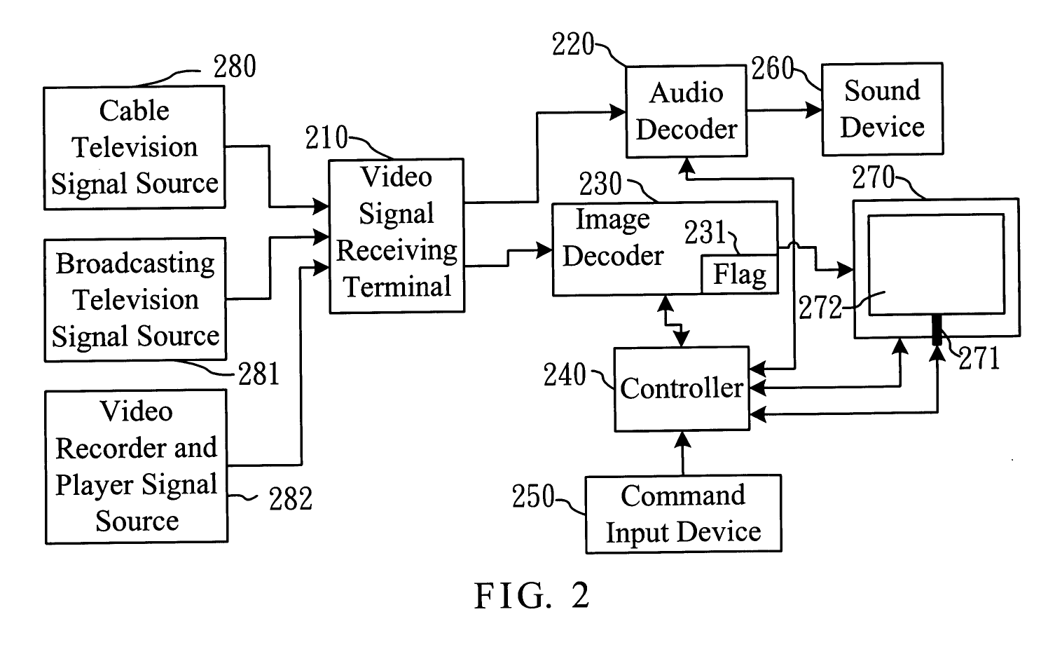

FIG. 2 is a block diagram of a liquid crystal display television capable of automatically turning off a backlight source on a panel thereof in accordance with the invention, which turns off the backlight source on the panel in case of no video signal. The liquid crystal display television includes a video signal receiving terminal 210, an image decoder 230, a liquid crystal display television panel 270, a controller 240, an audio decoder 220, a sound device 260 and a command input device 250.

The video signal receiving terminal 210 receives a video signal and demodulates the video signal to thereby produce an image transport stream and an audio transport stream. The video signal can originate from a cable television signal source 280, a broadcasting television signal source 281 or a video recorder and player signal source 282.

The image decoder 220 is connected to the video signal receiving terminal 210 in order to receive and decode the audio transport stream to thus produce an audio signal. The sound device 260 is a speaker connected to the audio decoder 220 in order to play the audio signal.

The image decoder 230 is connected to the video signal receiving terminal 210 in order to receive and decode the image transport stream to thus produce an image signal. The image decoder 230 has a flag 230 containing a first state and a second state. The first state indicates that the image transport stream exists, and the second state indicates that the image transport stream does not exist.

The liquid crystal display television panel 270 receives the image signal for playing and has a backlight control terminal 271 with a first level and a second level. When the backlight control terminal 271 is at the first level, a backlight source 272 on the liquid crystal display television panel 270 is turned on. When the backlight control terminal 271 is at the second level, the backlight source 272 on the liquid crystal display television panel 270 is turned off.

The controller 240 is connected to the audio decoder 220, the image decoder 230 and the liquid crystal display television panel 270 for initialization and working mode setup.

The command input device 250 is connected to the controller 240 in order to receive an instruction. The command input device 250 can be a plurality of buttons implemented on an operation panel (not shown). The command input device 250 can be an infrared receiver implemented on the operation panel in order to receive an instruction from an infrared remote controller (not shown).

When the signal source exists, the flag 230 is of the first state to indicate that an image transport stream exists. In this case, the controller 240 detects the flag as the first state and accordingly produces a control signal to set the backlight control terminal 271 to the first level. Thus, the backlight source 272 on the liquid crystal display television panel 270 is turned on.

When the signal source does not exist, the flag 230 is of the second state to indicate that the image transport stream does not exist. In this case, the controller 240 detects the flag as the second state and accordingly produces a control signal to set the backlight control terminal 271 to the second level. Thus, the backlight source 272 on the liquid crystal display television panel 270 is turned off.

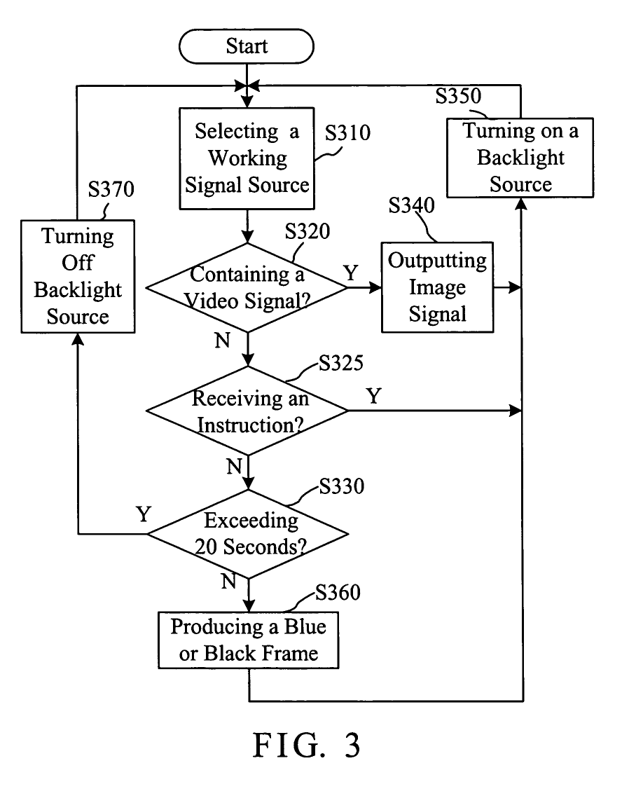

FIG. 3 is a flowchart of a method capable of automatically turning off a backlight source on a panel of a liquid crystal display television in accordance with the invention. In step S310, the liquid crystal display television selects a signal source as a working signal source. Step S320 determines whether the working signal source contains a video signal; if yes, step S340 is executed; and if not, step S325 is executed.

In step S340, since the working signal source contains the video signal, the image decoder 230 receives the video signal, produces an image transport stream, and decodes the image transport stream to thus produce an image signal. The image decoder 230 sets the flag 230 to the first state to indicate that the image transport exists such that the controller 240 detects the flag 230 as the first state and accordingly produces a control signal to set the backlight control terminal 271 to the first level. Thus, the backlight source 272 on the liquid crystal display television panel 270 is turned on (step S350).

Step S325 determines whether the command input device 250 receives an instruction; if yes, it indicates that a user performs an operation on the liquid crystal display television and step S350 is executed; and if not, step S330 is executed. Step S330 indicates that the working signal source has no video signal, and accordingly determines whether a period of no video signal exceeds a predetermined time such as 20 seconds; if not, step S360 is executed; and if yes, i.e., the period exceeds 20 seconds, step S370 is executed.

Step S360 indicates that the working signal source has no video signal and the period of no video signal does not exceed 20 seconds, and accordingly displays a blue or black frame. Step S370 indicates that the signal source has no video signal and the period of no video signal exceeds 20 seconds, and accordingly sets the flag 230 to the second state to thereby indicate that the image transport stream does not exist. Thus, the controller 240 detects the flag 231 as the second state, and accordingly produces a control signal to set the backlight control terminal 271 to the second level, turns off the backlight source 272 on the liquid crystal display television panel 270, and lights an LED on the liquid crystal display television panel 270.

In view of the foregoing, it is known that, in the present invention, when the liquid crystal display television cannot receive the signal and the predetermined time (in this case, 20 seconds) is passed, the backlight source 272 on the liquid crystal display television panel 270 is automatically turned off until the signal is received or an button is pressed, thereby saving the power and prolonging the use life of the liquid crystal display television panel 270.

Although the present invention has been explained in relation to its preferred embodiment, it is to be understood that many other possible modifications and variations can be made without departing from the spirit and scope of the invention as hereinafter claimed.

What is claimed is:

1. A liquid crystal display television capable of automatically turning off a backlight source, which turns off the backlight source in case of no video signal, the liquid crystal display television comprising:
a video signal receiving terminal, which receives a video signal and demodulates the video signal to thereby produce an image transport stream and an audio transport stream;
an image decoder, which is connected to the video signal receiving terminal in order to receive the image transport stream and decode the image transport stream to thus produce an image signal, and has a flag containing a first state and a second state, wherein the first state indicates that an image transport exists, and the second state indicates that the image transport does not exist;
a liquid crystal display television panel, which receives the image signal for playing and has a backlight control terminal with a first level and a second level such that a backlight source on the liquid crystal display television panel is turned on when the backlight control terminal is at the first level, and the backlight source on the liquid crystal display television panel is turned off when the backlight control terminal is at the second level; and
a controller, which is connected to the image decoder and the liquid crystal display television panel for initialization and working mode setup;
wherein the controller produces a control signal to set the backlight control terminal to the first level when the flag is detected as the first state, and to the second level when the flag is detected as the second state.

2. The liquid crystal display television as claimed in claim 1, further comprising an audio decoder, which is connected to the video signal receiving terminal in order to receive and decode the audio transport stream to thereby produce an audio signal.

3. The liquid crystal display television as claimed in claim 2, further comprising a sound device, which is connected to the audio decoder in order to play the video signal.

4. The liquid crystal display television as claimed in claim 1, wherein the video signal originates from a cable television signal source.

5. The liquid crystal display television as claimed in claim 1, wherein the video signal originates from a broadcasting television signal source.

6. The liquid crystal display television as claimed in claim 1, wherein the video signal originates from a video recorder and player signal source.

7. A method capable of automatically turning off a backlight source on a panel of a liquid crystal display television, which turns off the backlight source in case of no video signal, the method comprising the steps of:
(A) selecting a signal source as a working source for the liquid crystal display television;
(B) determining whether the working signal contains a video signal;
(C) determining whether an instruction is received when no video signal is determined in step (B);
(D) further determining whether a period of no video signal exceeds a predetermined time when no instruction received is determined in step (C); and
(E) turning off the backlight source on the panel of the liquid crystal display television when the period of no video signal exceeding the predetermined time is determined in step (D).

8. The method as claimed in claim 7, further comprising the steps of:
(F) receiving and decoding the video signal to accordingly produce an image signal when containing the video signal is determined in step (B); and
(G) turning on the backlight source on the panel of the liquid crystal display television in order to display the image signal.

9. The method as claimed in claim 8, further comprising the step of:
(H) producing a blue or black frame and executing step (G) when the period of no video signal not exceeding the predetermined time is determined in step (D).

10. The method as claimed in claim 8, further comprising the step of:
(I) executing step (G) when the instruction received is determined in step (C).

11. The method as claimed in claim 9, wherein the predetermined time is 20 seconds.
